(19) United States
(12) Patent Application Publication
(10) Pub. No.: US 2008/0301114 A1
(43) Pub. Date: Dec. 4, 2008

(54) METHOD AND SYSTEM FOR A PROFESSIONAL SOCIAL NETWORK

(76) Inventors: Jason S. HIBBETS, Raleigh, NC (US); Darryl L. Pierce, Apex, NC (US)

Correspondence Address: MH2 TECHNOLOGY LAW GROUP (Cust. No. w/Red Hat), 1951 KIDWELL DRIVE, SUITE 550, TYSONS CORNER, VA, 22182, US

(21) Appl. No.: 11/756,288

(22) Filed: May 31, 2007

(51) Int. Cl. G06F 17/30

(52) U.S. Cl. 707/5; 707/E17.001

(57) ABSTRACT

An embodiment relates generally to a method of providing a professional social network. The method includes providing a plurality of services in a service portal and providing for a plurality of service providers. Each service provider has an associated rating and review at least once and is associated with a service of the plurality of services. The method also includes receiving a request for a selected service and providing a sub-plurality of service providers of the plurality of service providers in response to the request, where the sub-plurality of services providers are ordered based on the associated rating and review.

### FIELD

This invention relates generally to computer services, more particularly, to systems and methods for a professional social network.

### DESCRIPTION OF THE RELATED ART

The businesses of the Fortune 500 spend large sums of money on their information technology (IT) infrastructure. The investment in IT can improve efficiency and productivity of a business in sales, accounting, financial support, research, etc.

Although these businesses often purchase large amounts of hardware and software, they also have the financial wherewithal to hire staff to maintain their IT infrastructure. The IT departments of these businesses can assist the users with software and user errors as well as tending to any broken hardware. The IT department can also plan for future improvements in the software and hardware. The IT department can also be responsible for training of the users in the IT system, which includes supported software applications and underlying hardware. Most importantly, the IT department can recover the IT infrastructure in the event of a catastrophic event.

Small businesses typically do not have the financial resources to afford an IT department. However, small businesses need the services that an IT department of a Fortune 500 company can provide: technical support in the event of a hardware and/or software failures, training of new employees in the existing system, integrate new technologies (software/hardware), etc.

Since small businesses cannot typically afford a full-time IT staff, a typical small business can hire consultants or go to a computer services company to implement and support their IT infrastructure. However, this is typically an unsatisfactory solution because the small business has to take the time to search for the consultants and/or services company and to verify their credentials. Moreover, the small business may not initially know where to look for the appropriate help.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 depicts an exemplary system in accordance with an embodiment;

FIG. 2 illustrates an exemplary service portal of the system shown in FIG. 1 in accordance with another embodiment;

FIG. 3 depicts an exemplary knowledge server of the system shown in FIG. 1 in accordance with yet another embodiment;

FIG. 4 illustrates an exemplary issue tracker server of the system shown in FIG. 1 in accordance with yet another embodiment;

FIG. 5 depicts an exemplary chat server of the system shown in FIG. 1 in accordance with yet another embodiment;

FIG. 6 illustrates an exemplary diagram of the professional social network module in accordance with yet another embodiment;

FIG. 7 depicts an exemplary flow diagram implemented by the professional social network module in accordance with yet another embodiment;

FIG. 8 illustrates another exemplary flow diagram implemented by the professional social network module in accordance with yet another embodiment; and

FIG. 9 depicts yet another exemplary flow diagram implemented by the professional social network module in accordance with yet another embodiment.

### DETAILED DESCRIPTION OF EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, all types of information portals, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Embodiments pertain generally to a professional social network. More particularly, a service portal can be configured to provide for a professional social network (“PSN”) module where users can be matched up with independent software vendors, hardware vendors, and/or consultants, i.e., collectively referred to herein as service providers. The service providers can be rated and reviewed by the user community. The user community can provide a rating (based on a graded scale, e.g., one to five stars) and a review or the user community can provide a secondary review of an existing rating and review, i.e., “was this rating and review helpful or useful?” The positive secondary reviews along with the number of secondary reviews can increase the ranking of the selected service provider. Similarly, negative secondary reviews along with the number of secondary review factor into lowering the ranking of the selected service provider. Accordingly, this is a mechanism for subsequent users to select the most capable service provider based on user community feedback and/or on reputation of the service provider. For example, a user can request all four star rated consultants with Red Hat Enterprise Linux experience. The PSN module can return a list of the four star rated consultants ranked with the highest rated consultants in the initial part of the search results.

In some embodiments, the PSN module can be configured to the order the search results not only by ranking but also by geographic closeness to a user. More specifically, the PSN module can retrieve the address of the user and a service provider from their respective profiles, translate the address to latitude/longitude (“lat/long”) coordinates and calculate a distance. Accordingly, the search results can then be ordered by highest ranking as well as locality.

Independent software vendors (“ISVs”), hardware vendors, consultants, trainers or any other entity can enter the service portal and add products and any associated services for the user community. The PSN module can be configured to maintain two lists: a pending list and a certified list. The pending list contains all the service providers that have newly been entered into the service portal and have not been reviewed by someone in the user community. The certified list contains all the service providers that have at least one rating and review. A service provider can move from the pending list to the certified list by having a user review the service provider.

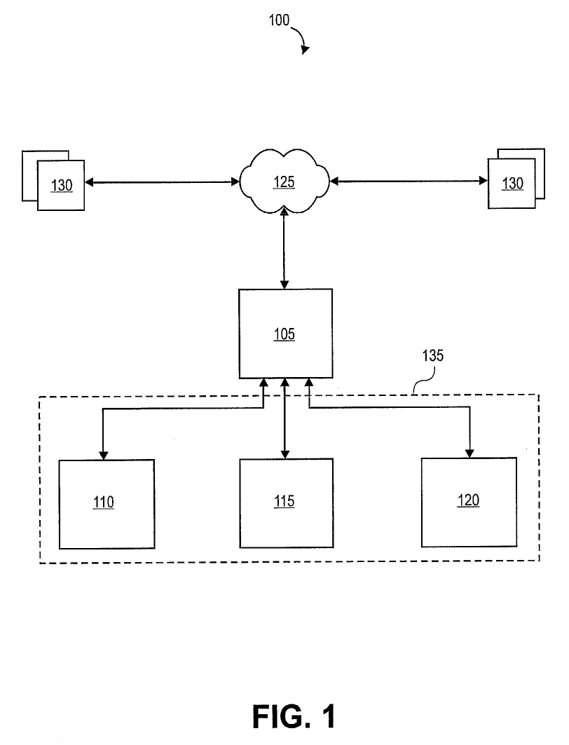

FIG. 1 illustrates an exemplary system 100 in accordance with an embodiment. It should be readily apparent to those of ordinary skill in the art that the system 100 depicted in FIG. 1 represents a generalized schematic illustration and that other components may be added or existing components may be removed or modified. Moreover, the system 100 may be implemented using software components, hardware components, or combinations thereof.

As shown in FIG. 1, the system 100 includes a service portal 105 coupled to a network 125. Users 130 can interface with the service portal 105 through the network 125. The network 125 can be a combination of local area networks, wide area networks, public networks, and private networks or combinations thereof such as the Internet.

The users 130 can be interface with the service portal 105 using computing platforms such as personal computers, workstations, private local area networks (e.g., business entity or government entity) or other similar device that can provide network access and interact with the service portal 105.

In some embodiments, the service portal 105 can be configured to provide a variety of services. As a non-limiting example, the service portal 105 can be configured to provide information for users to research, compare and purchase software, hardware and consulting services in support of the those software and/or hardware purchases. The service portal 105 can also be configured to provide support services by subscription to those same software and/or hardware purchases. The service portal 105 can further be configured to provide a knowledgebase for a user in a community to search for answers regarding issues. The community can comprise registered and non-registered users.

The service portal 105 can be configured to provide at least the described services with a service backend 135. The service backend 135 can comprise at least a knowledge server 110, an issue tracker server 115 and a chat server 120.

The knowledge server 110 can be configured to provide knowledgebase for the system 100. The knowledgebase can comprise of Wiki pages, articles, frequently asked questions, transcripts of chat sessions, forums, and other informational items related to issues deemed worth discussing by the community. The knowledge server 110 can also be configured to search and retrieve requested informational items from third party sites such as Google™, Yahoo™, etc. The knowledge server 110 can then rank and prioritize the search results from internal and external sources for the requesting user based on a single interface provided by the server portal 105. In some embodiments, the knowledge server 110 can be implemented on a separate server using open-source technologies.

The service portal 105 can also be configured to interface with the issue tracker server 115, which provides support services for the service portal 105. More particularly, a user may have a problem or issue with a purchased software and/or hardware from the service portal 105. The user can return to the service portal 105 and request support services based on a purchased service subscription through a user interface generated by the service portal 105. The service portal 105 can redirect the support request to the issue tracker server 115. The issue tracker server 115 can open an associated service ticket for resolution by support personnel. The issue tracker server 115 can also be configured to attach transcripts of any chat sessions between the support personnel and the user as well as documenting any solution(s) to the issue of the user. In some aspects, the documented solution can be converted into an article, added to a frequently asked question list, Wiki page, etc., and passed onto the knowledge server 110.

The chat server 120 can be configured to couple with the service portal 105. A user with an issue or question can log into the service portal 105 and search for solutions and/or answers. The service portal 105 can generate a user interface and display an option for requesting assistance via a chat session. If a user selects this option, the service portal 105 can pass the request over to the chat server 120. The chat server 120 can be configured to provide the chat session to the user via another user interface provided by the service portal 105. The chat server 120 can also be configured to save the chat sessions for later review. For example, support personnel can turn the chat session into an article or extract discussed solutions in the chat sessions into or add to a frequently asked questions list.

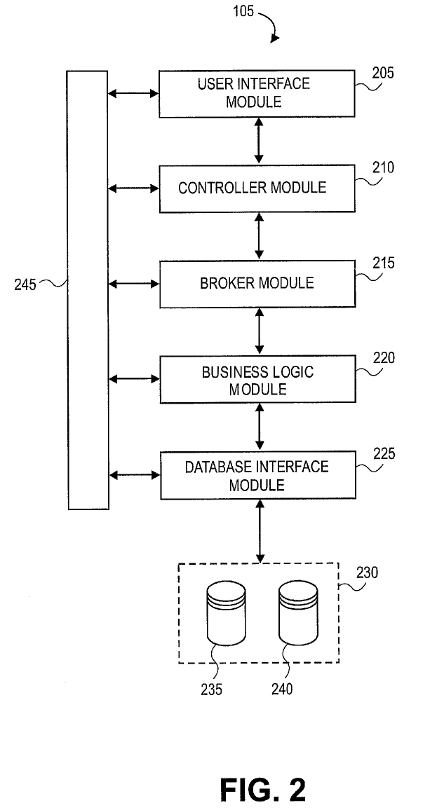

FIG. 2 illustrates a more detailed block diagram of the service portal 105 in accordance with another embodiment. It should be readily apparent to those of ordinary skill in the art that the service portal 105 depicted in FIG. 2 represents a generalized schematic illustration and that other components may be added or existing components may be removed or modified.

As shown in FIG. 2, the service portal 105 can comprise a user interface module 205, a controller module 210, a broker module 215, a business logic module 220, a database interface module 225, and a logging module 245. The user interface module 205 can be configured to generate the graphical user interfaces (“GUIs”) for users to interact with service portal 105. The user interface module 205 can generate the necessary functionality of the GUIs based on hypertext markup language (“HTML”) code, cascading style sheets (“CSS”) and/or Java Server Pages (“JSP”).

The user interface module 205 can be configured with a controller module 210, which is configured to provide code support for the functionality embedded in the GUIs of the user interface module 205. More particularly, the controller module 210 can comprise of DWR, Dojo, and a library of JavaScript apps. The controller module 210 can be implemented using direct web remoting (DWR). DWR can be considered a Java and JavaScript open source library which allows a programmer to write Asynchronous JavaScript and XML (“Ajax ”) web applications or interactive web applications. DWR allows generally JavaScript code in the GUI generated by the user interface module 205 to use Java methods.

The Dojo component can be considered an open-source JavaScript Toolkit to construct the dynamic web user interfaces. As such, the controller module 210 can dynamically generate user interfaces to pass along to the user interface module 205 for display to a user.

The library of JavaScript apps can define a list of pre-determined functionality that users are likely to call. For example, one JavaScript can be “Get Price of Product X”.

The controller module 210 can also be coupled with the broker module 215. The broker module 215 can be configured to provide a high-level business logic for the service portal 105. More particularly, the business logic can generally filter and direct an incoming request to the appropriate server of the service backend 135 (shown in FIG. 1). For example, the broker module 215 can receive a request for delivery terms on a selected piece of hardware. The broker module 215 can identify the server that can satisfy the request, e.g., service portal 105, and forward the request to the identified server. Similarly, a request for technical support can be identified by the broker module 215 and be forwarded to the issue tracker server 115 to be serviced.

The broker module 215 can also be coupled with business logic 220, which is configured to contain the logic to provide the desired business services from the broker module 215 such as processing requests for the database 230. The business logic module 225 can also provide a schema for inquiries to the databases 230. The databases 230 can, abstractly, contain two databases: a user profile database 235 and a product catalog 240. The databases 230 can be implemented using any type of database systems provided by vendors such as MySQL, Oracle, Sybase, International Business Machines, etc. The business logic module 220 can provide the schema to formulate queries to pass to the databases 230 through the database interface module 225. The business logic 220 can be implemented using an open source lightweight framework such as Spring Application Framework supported by data access objects, beans, and manager.

The database interface module 225 can be configured to provide an abstraction between the databases 230 and the business logic module 220. The database interface module 225 can be implemented with Hibernate or other similar abstractions. The database interface module 225 provides object relational mapping and persistence management with the databases 230.

The modules 205-225 of the service portal 105 can also be implemented using an open source servlet container and webserver such as Tomcat™ in some embodiments. Other embodiments could use proprietary servlet container and webserver technologies.

The logging module 245 can be configured to couple with the user interface module 205, the controller module 210, the broker module 215, the business logic module 220 and the database interface module 225. The logging module 245 can also be configured to provide logging and exception handling for all the coupled modules 205-225. The aforementioned module can provide functions which may be commonly called by the rest of the modules 205-225 of the service portal 105. The logging module 245 can be implemented using aspect-oriented programming as known to those skilled in the art.

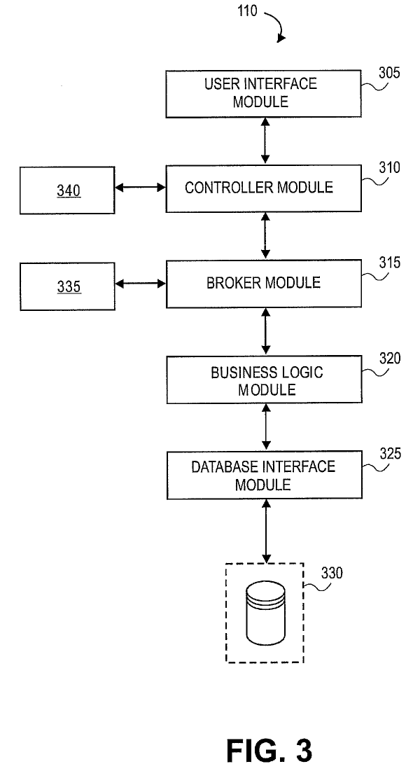

FIG. 3 illustrates a more detailed block diagram of the knowledge server 110 in accordance with another embodiment. It should be readily apparent to those of ordinary skill in the art that the knowledge server 110 depicted in FIG. 3 represents a generalized schematic illustration and that other components may be added or existing components may be removed or modified.

FIG. 2 and FIG. 3 share some common components. As such, the description of the common components is being omitted and the description of these components with respect to the FIG. 2 is being relied upon to provide adequate description of the common components.

As shown in FIG. 3, the knowledge server 110 can comprise at least a user interface module 305, a controller module 310, a broker module 315, a business logic module 320 and a database interface module 325.

Similar to the service portal 105, the user interface module 305 of the knowledge server 110 can be configured to provide the GUIs for users to interact with the knowledge server 110. The functionality for selected actions by the users is provided by the controller module 310. The controller module 310 can be configured to provide the associated code for the requested functionality of the selected action in the GUI. The broker module 315 can be configured to provide high-level business logic for the knowledge server 110. More particularly, the broker module 315 can provide filtering for the requests entering the knowledge server 110. For these requests, the broker module 315 can receive these requests from the service portal 105 through the server interface 335. The server interface 330 can be implemented using simple object access protocols, web services, etc. The knowledge server 110 can also user the server interface 335 to return requested information to the service portal 105. Unlike the service portal 105, the knowledge server 110 can be configured to prevent direct access to the knowledge server 110 but can only be accessed through the service portal 105.

The broker module 315 of the knowledge server 110 can also be coupled to the business logic module 320, which is configured to contain the logic to provide the desired business services as received from the broker module 315 such as processing requests for the database 330. The business logic module 325 can also provide a schema for queries into the knowledgebase database 330. The database interface module 325 can be configured to provide a level of abstraction between the queries from the broker module 320 to the actual physical implementation of the knowledgebase database 330. As previously described, the knowledgebase database 330 can be implemented with database architectures provided by vendors such as MySQL, Oracle, Sybase, International Business Machines, and other similar manufacturers.

The modules 305-325 of the service portal 105 can also be implemented using an open source servlet container and webserver such as Tomcat™ in some embodiments. Other embodiments could use proprietary servlet container and webserver technologies.

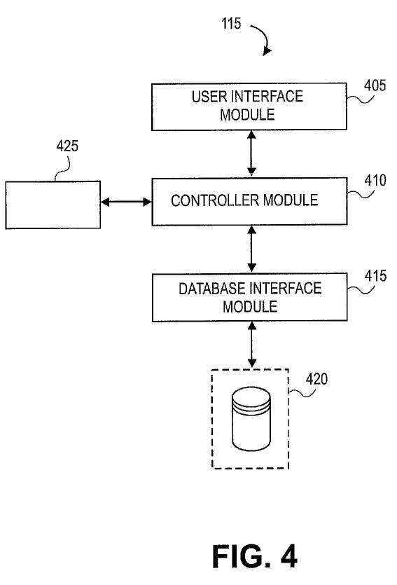

FIG. 4 illustrates a more detailed block diagram of the issue tracker server 115 in accordance with another embodiment. It should be readily apparent to those of ordinary skill in the art that the issue tracker server 115 depicted in FIG. 4 represents a generalized schematic illustration and that other components may be added or existing components may be removed or modified.

As shown in FIG. 4, the issue tracker server 115 can comprise a user interface module 405, a controller module 410, a database interface module 415, and a server interface 425. Similar to the service portal 105 and the knowledge server 110, the user interface module 405 of the issue tracker server 115 can be configured to generate GUIs for the service portal 105 to interface thereto. As with the knowledge server 110, the service portal 105 provides a unified interface to the issue tracker server 115. The service portal 105 can be configured to receive requests from users to access the issue tracker server 115. The received requests are processed by the issue tracker server 115 and any information is returned using the issue tracker server's GUIs as generated by the user interface module 405. The service portal 105 reformats any returning information from the issue tracker server 115 and the other servers in a unified GUI generated by the user interface module 205 of the service portal 105. In some instances, the service portal 105 can generate an overlay for data arriving from the other servers (110-120). Accordingly, a user can be presented with information in a consistent format.

The user interface module 405 can be implemented using HTML code, CSS sheets, HyperText Pre-Processor (“PHP”) code and/or Ruby on Rails (ROR) code. The controller module 410 can provide the associated code for the functionality provided by the GUIs generated by the user interface module 405.

The controller module 410 can be configured to communicate with the service portal 105, the knowledge server 110 and the chat server through a communication interface 425. The communication interface 425 can use SOAP or web service protocols over the Internet to provide the communication channel.

The controller module 410 can also be configured to interface with the database 420. The database 420 can be configured to store the open and closed service tickets. The database 420 can also be configured to store links to or the actual articles, chats session used to resolve the issue. In some embodiments, the database 420 can be implemented using MySQL 5.x database or other open source database. Other embodiments, the database 420 can be implemented using proprietary databases such as Oracle, Sybase, IBM, etc.

Although FIG. 4 depicts the user interface module 405, controller module 410, and the database interface module 415 as separate components, these modules (405-415) can be implemented using LAMP, which is an open source Web development platform based on Linux, Apache, MySQL, and PHP.

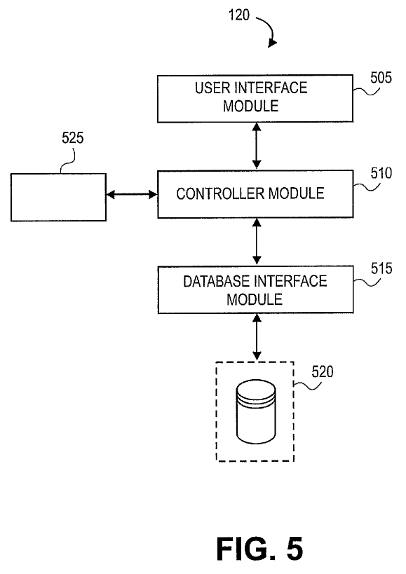

FIG. 5 illustrates a more detailed block diagram of the chat server 120 in accordance with another embodiment. It should be readily apparent to those of ordinary skill in the art that the chat server 120 depicted in FIG. 5 represents a generalized schematic illustration and that other components may be added or existing components may be removed or modified.

The chat server 120 can be configured to provide chat services for users. The chat server 120 can provide a communication link between users and a group of support personnel. The chat server 120 can also provide a communication link between users of the service portal 105. The users can request access to support through a GUI of the service portal 105. Some embodiments can use Openfire to provide group and instant messaging service using the Extensible Messaging and Presence Protocol (“XMPP”).

As shown in FIG. 5, the chat server 120 can comprise a user interface module 505, a controller module 510, a database interface module 515 and a database 520. The user interface module 505 of the chat server 120 can be configured to generate GUIs for the service portal 105 to interface thereto. The user interface module 505 can be implemented using HTML code, CSS, and/or Java Server pages.

As with the knowledge server 110 and the issue tracker server 115, the service portal 105 provides a unified interface to the chat server 120. The service portal 105 can be configured to receive requests from users to access the chat server 115. The received requests are processed by the chat server 120 to start a chat session with someone from a group of technical support personnel.

The received requests for chats can be processed by the controller module 510, which contains the associated code for the selected function in the GUI by a user. The controller module 510, in some embodiments, can be implemented using DWR.

The controller module 510 can also interface with a database interface module 515. The database interface module 515 can be configured to translate queries from the controller module 510 to appropriate format of the database 520 to store and retrieve information. The information stored in the database 520 can comprise of chat sessions between users and support personnel. In some embodiments, the database 520 can be implemented with a MySQL database. Returning to the database interface module 515, this module 515 can be implemented using plain old Java objects as known to those skilled in the art.

Although FIG. 5 depicts the user interface module 505, controller module 510, and the database interface module 515 as separate components, other embodiments can implement the functionality of these modules can be implemented using Tomcat Servlet container and web server from Apache Software Foundation.

Returning to FIG. 3, the knowledge server 110 can be configured with a professional social network (“PSN”) module 340 embedded in the controller module 310. The PSN module 340 can be configured to provide a mechanism for users to rate and comment on service providers and to rate the initial rating and commentary on the service providers. The PSN module 340 can be configured to receive the names of the service providers (ISVs, hardware vendors, consultants, trainers, or any other type of business/social entity) and any associated products and/or services through the service portal 105. Initially, the new service providers can be placed on a pending list.

A service provider can be pulled directly from the pending list or may arise in a typical search (e.g., find all vendors that support XYZ email application). The PSN module 340 can then be configured to allow a reviewer to assign a rating on a predetermined scale (e.g., one to five stars) to the service provider, as well attach any commentary regarding the service provider (e.g., effectiveness, ease of use, etc.).

The PSN module 340 can also be configured allow subsequent reviewers/users to provide a secondary evaluation of the service provider as well as another rating and associated commentary. Thus, a subsequent user can assess the service provider as well as the initial rating and associated commentary.

The PSN module 340 can be further configured to provide a ranking based on the rating, associated commentary and the secondary ratings based on a predetermined formula or heuristic. For example, one heuristic could be to place greater weight to the secondary ratings than initial rankings and/or associated commentary. The predetermined formula or heuristic can be tailored to the needs and goals of the user as known to those skilled in the art.

As the ranking of the service provider increases, this indicates that the user community service provider is a credible source of information and the author of the associated commentary gains status as an expert. Conversely, if the ranking falls, this is an indication that the user community does not deem the service provider worthwhile and/or the reviewer worthwhile. The ranking of the service provider can also be used as a method of displaying search results. More particularly, when the search results are returned, the results are ordered according to ranking, higher ranking are shown preferentially. Accordingly, the user community can be provided a recommendation system and verification mechanism to assess the service provider as well as initial reviewers.

In some embodiments, the search results can also be further ordered according to locality if selected by the user. More specifically, the PSN module 340 can be configured to retrieve the street address from the requesting user as well as the selected service provider. The PSN module 340 can be configured to translate the street addresses into lat/long coordinates. This conversion can be provided by map service providers such as MapQuest, MapPoint, NavTeq, etc. The PSN module 340 can determine a distance between a service provider and the requesting user based on the differences between the lat/long coordinates. Accordingly, the search results can then be ordered by ranking and geographic closeness to the requesting user.

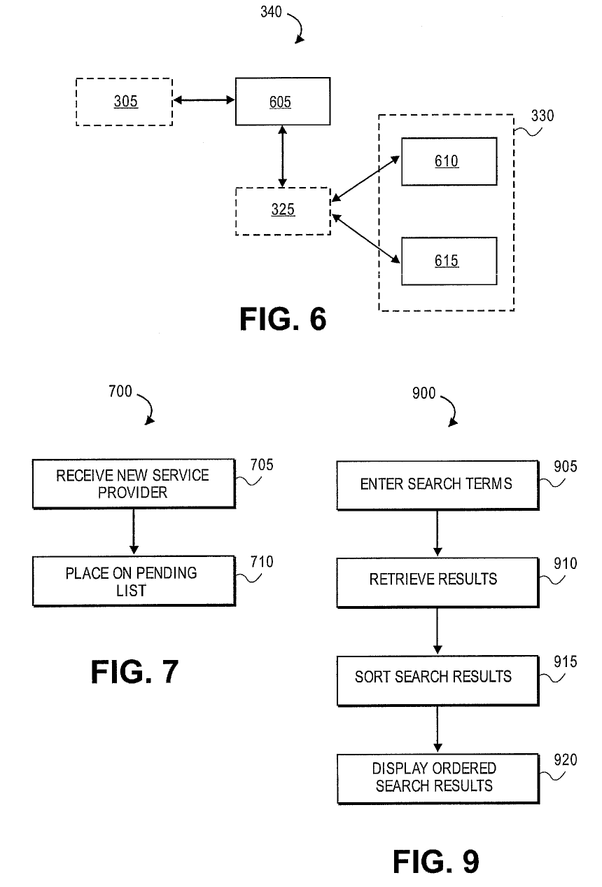

FIG. 6 illustrates a block diagram of the PSN module 340 in accordance with yet another embodiment. It should be readily apparent to those of ordinary skill in the art that the PSN module 340 depicted in FIG. 6 represents a generalized schematic illustration and that other components may be added or existing components may be removed or modified.

As depicted in FIG. 6, the PSN module 340 comprises of a manager module 605 coupled to the user interface module 305, and the database interface module 325. The manager module 605 is configured to implement the functionality of the PSN module 340 as previously described and described in greater detail below with respect to FIGS. 7-9. The manager module 605 can be implemented in software code (Java, C, C++, etc.), hardware device (application specific integrated circuit, field programmable gate array, microprocessor, etc.) or combinations thereof.

Although manager module 605 is depicted as a separate module in FIG. 3, it is readily obvious to those of ordinary skill in the art that the functionality of the manager module 605 can be implemented within the controller module 310 or the broker module 315 without departing from the teachings of the present invention.

The manager module 605 can access the user interface module 305 through the existing controller module 310 interfaces with the user interface module 305 as previously described. The user interface module 305 can be configured to generate GUIs to allow a user, among other things, to search the knowledgebase database 330 (i.e., knowledgebase), review ratings and associated reviews (or commentary) of selected service providers, and to display search results.

The manager module 605 can be configured to access the database 330 through the existing pathways between the controller module 310 and the database interface module 325 as previously described and known to those skilled in the art. Accordingly, the manager module 605 can issue requests to the knowledgebase database 330 to search and retrieve items from the knowledgebase database 330. The knowledgebase database 330 can be configured to maintain two lists: a pending list 610 and a certified list 615. The pending list 610 can store the service providers that have not yet been reviewed and the certified list 615 can store the service providers that have been reviewed. Alternatively, the knowledgebase database 330 can track between pending and certified service providers by maintaining a flag (abit or a field) which can indicate a state of pending or state of certified.

In some embodiments, the knowledgebase database 330 can also be configured to store Wiki pages, articles, blogs, etc., and associated metadata for the service providers. The associated metadata can include, among other things, tags, rating information, commentary, and/or a ranking.

The manager module 605 can be configured to invoke the GUI module 305 to generate a GUI requesting a user to evaluate a selected service provider and associated products/services. The selected service provider can either be a new (or pending) service provider in the knowledgebase database 330 or a previously reviewed service provider.

If the user is evaluating a pending service provider, the GUI module 305 can be configured to generate a GUI requesting the user to rate the service provider (e.g., one to five stars) and request a commentary or review of the same. The generated GUI can be configured to require that the user enter the rating and the associated commentary for the reviewed service provider.

The manager module 605 can then pass a request to store the requested rating and commentary in the knowledgebase database 330 through the database interface module 325. The manager module 605 can also place a link or pointer in the metadata associated with the selected service provider so the rating and commentary can be subsequently retrieved and place or set a flag to indicate that the service provider is certified. The manager module 605 can be further configured to generate an initial ranking based on the rating and commentary and store this ranking in the metadata of the selected service provider.

If the user reviews a previously reviewed service provider, the manager module 605 can be configured to invoke the GUI module 305 to generate a GUI requesting the user to evaluate the previously given rating and commentary as a secondary rating. The GUI can request the user to evaluate whether the rating/commentary were accurate, helpful, useful, and other user-determined criteria.

After the user inputs the secondary rating, the manager module 605 can be configured to store the secondary rating in the knowledgebase database 330 through the database interface module 325. The manager module 605 can also store a link or pointer to the location of the secondary rating in the knowledgebase database 305 in the metadata of the selected service provider. The manager module 605 can be further configured to recalculate the ranking of the selected service provider that accounts for the secondary rating, which is subsequently stored in the metadata or a pointer to where the secondary rating is stored in the knowledgebase database 330.

Accordingly, subsequent users can search the knowledgebase database 330 and can be presented with search results based on the ranking. The items with higher rankings indicate that these items have been vetted by the user community and are very useful or to whatever criteria that the user community sets. The lower ranked items can indicate that these items are unreliable, useful, or haven't been review enough.

FIG. 7 illustrates a flow diagram 700 implemented by the PSN module 340. It should be readily apparent to those of ordinary skill in the art that the flow diagram 700 depicted in FIG. 7 represents a generalized schematic illustration and that other steps may be added or existing steps may be removed or modified.

As shown in FIG. 7, the PSN module 340 can be configured to receive a new service provider, in step 705. More specifically, a new service provider may have logged into the service portal 105 and requested to enter the name of the service provider into the professional social network maintained by the service portal 105. The professional social network can be a group of ISVs, hardware vendors, consultants trainers, or other entities offering services/products for the user community (such as landscaping, personal grooming, pet services, etc).

In step 710, the manager module 605 of the PSN module 340 can be configured to store the newly entered service provider into the knowledgebase database 330 on the pending list 610. Alternatively, the manager module can set a flag to indicate that the newly entered service provider is in a pending mode. Subsequently, the manager module 605 can return to a wait or idle state.

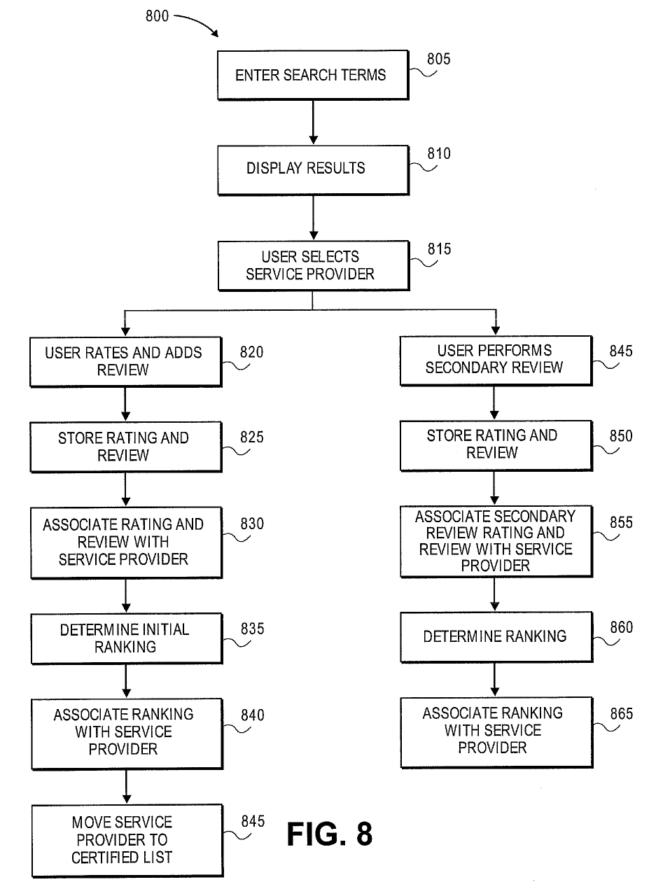

FIG. 8 illustrates a flow diagram 800 implemented by the PSN module 340. It should be readily apparent to those of ordinary skill in the art that the flow diagram 700 depicted in FIG. 8 represents a generalized schematic illustration and that other steps may be added or existing steps may be removed or modified.

As shown in FIG. 8, a user can be reviewing a new or a previously unreviewed service provider by entering search terms, in step 805. More particularly, the user may have accessed the service portal 105 through his local computer via a web browser such as Opera, Mozilla, Internet Explorer, or other similar web browser applications. The service portal 105 presented a GUI for the user to search for service providers in the pending lists 605 and certified lists 610 of the knowledgebase database 330. The service portal 105 can be configured to process the request for the selected query to the controller module 215 of the service portal 105 and forward the request to the knowledge server 110 through the server interface 335.

The knowledge server 110 can be configured to process the request through the broker module 315 of the knowledge server 315, which passes the request through the business logic module 320 and database interface module 325. The items matching the request are returned from the knowledgebase database 330 and possibly other third-party sources can then be returned to the service portal 105 for display to the user, in step 810.

The user module 205 of the service portal 105 can be configured to generate a GUI that displays the search results. The search results can be displayed by ranking as well as a graphical indicator whether or not the selected item has been rated or previously viewed. The user or reviewer may then select a new or previously un-reviewed service provider from the search results, in step 815.

If the user selects a non-reviewed service provider from the previously described GUI, in step 815, the user can evaluate the selected service provider, with a numerical and/or alphabetical designation representing the rating of the service provider after an examination thereof, in step 820. More particularly, the manager module 605 can be configured to invoke the GUI module 305 to generate a GUI that displays a rating panel, which is configured to receive a rating by the reviewer. For example, the rating panel or box can contain a number of checkboxes associated with a numerical scale (e.g., one-to-five, one-to-ten, etc., where the higher the number indicates greater satisfaction or utility). Accordingly, the user can select a rating for the selected service provider.

As an alternative to the previously described steps 805-810, the PSN module 340 can be configured to query the user via a dialog box if a user would review a pending service provider. The PSN module 340 can be configured to check a user profile of logged in users to determine whether they have expertise in a particular product and/or service. If the PSN module 340 determines that user profile matches a pending service provider, the PSN module 340 can query the user for a rating and commentary for the selected service provider's product and/or service.

In some embodiments, the generated GUI can be configured to require that the reviewer also input a commentary or review of the selected service provider. For example, the generated GUI can be configured not to proceed until a reviewer enters a review. The review can be an assessment of the accuracy, ease of understanding, a utility factor of the service provider, or other predetermined criteria set by a system administrator.

In step 825, the manager module 605 can be configured to store the rating and review in the knowledgebase database 330 by utilizing the database interface module 325. More particularly, a request to store the rating and review can be formulated by the manager module 605 for the database interface module 325 to execute. The database interface module 325 can return the location of the stored rating and review to the manager module.

In step 830, the manager module 605 can be configured to associate the selected rating and review with the selected service provider. More particularly, the rating and review given by the reviewer can be associated with the service provider by placing a link or pointer to the location of the rating and review in the metadata of the service provider in some embodiments.

In step 835, the manager module 605 can be configured to determine an initial ranking of the selected service provider. More specifically, the manager module 605 can use a predetermined formula or heuristic to determine the ranking of the selected service provider. The formula or heuristic can weigh the rating along with the presence of keyword in the review to arrive at a ranking.

In step 840, the manager module 605 can be configured to associate the ranking of the selected service provider by either placing a link to the location where the location is stored (e.g., knowledgebase database 330 or other predetermined persistent memory location) or storing the ranking in the metadata associated with the selected service provider. Subsequently, the selected service provider is committed to the knowledgebase database 330 with the updated metadata and places the selected service provider on the certified list 650 or sets a flag that indicates the selected provider is certified.

Returning to step 815, if the user selects a previously reviewed service provider, the manager module can be configured to request the GUI module 305 to generate another GUI. This GUI can be configured to query the user to perform a secondary review on the selected service provider.

In step 850 the manager module 605 can be configured to accept the secondary review. More specifically, the user may be requested to input an evaluation of the previous rating and commentary. For example, the user can be asked to place a rating on whether the rating was accurate, the review or commentary useful, or other user-defined goal. The user can use a rating panel box that accepts a alpha-numeric designation (e.g., number of stars, a scale of numbers, etc.) to capture the secondary review. In some embodiments, the secondary review can include commentary added by the reviewer.

In step 855, the manager module 605 can be configured to store the secondary rating and review in the knowledgebase database 330 by utilizing the database interface module 325. More particularly, a request to store the secondary rating and review can be formulated by the manager module 605 for the database interface module 325 to execute. The database interface module 325 can return the location of the stored secondary rating and review to the manager module 605.

In step 860, the manager module 605 can be configured to associate the secondary rating and review with the selected service provider. More particularly, the secondary rating and review given by the reviewer can be associated with the service provider by placing a link or pointer to the location of the rating and review in the metadata of the service provider.

In step 865, the manager module 605 can be configured to re-evaluate the existing ranking of the selected service provider. More specifically, the manager module 605 can use the predetermined formula or heuristic to re-evaluate determine the ranking of the selected service provider. An example of this re-evaluation can include the number of positive secondary reviews, which increases the ranking of the selected service provider.

In step 870, the manager module 605 can be configured to associate the ranking of the selected service provider by either placing a link to the location where the revised ranking is stored (e.g., knowledgebase database 330, or other predetermined persistent memory location) or storing the revised ranking in the metadata associated with the selected service provider. Subsequently, the selected service provider is committed to the knowledgebase database 330 with the updated metadata.

FIG. 9 illustrates a flow diagram 900 implemented by the PSN module 340 in accordance with yet another embodiment. It should be readily apparent to those of ordinary skill in the art that the flow diagram 900 depicted in FIG. 9 represents a generalized schematic illustration and that other steps may be added or existing steps may be removed or modified.

As shown in FIG. 9, in step 905, a user can enter search terms in a GUI generated by a service portal 105 to search for service providers in the knowledgebase database 330 of the knowledge server 110 via the PSN module 340. The user can enter random terms and/or use terms from a set of community of tag terms to search for service providers from the knowledgebase database 330 onto the selected GUI.

The PSN module 340 of the service portal 105 can be configured to format a request packet to the knowledge server 110, which is passed to the broker module 210 through the server interface 335 and the broker module 315 of the knowledge server 110.

The broker module 315 of the knowledge server 110 can be configured to formulate a query based on the business logic module 320 to pass to the knowledgebase database 330 through the database interface module 325, in step 910. More particularly, the query searches the pending list 610 and certified list 615 for service providers matching the search request. In some embodiments, the knowledge server 110 can be configured to search third party web sites with the selected terms. The third party web site results can be grouped and ranked with the results from the knowledgebase database 330, where the results from the certified list 615 are preferentially displayed by ranking along with results from the pending list 615 and third party websites, in step 915.

Moreover, the search results can be further ordered by locality if selected by the user. More specifically, the PSN module can be configured to retrieve the street address of the requesting user and each service provider in the search results. The PSN module 340 can then translate the street address into lat/long coordinates. The respective lat/long coordinate of the each service provider can be used to calculate a distance to the lat/long coordinate of the requesting user. Subsequently, the PSN module can filter the list to preferentially display the selected service providers with the highest ranking and geographic nearness to the requesting user.

In step 920, the broker module 315 of the knowledge server 110 can forward the search results in a ranked fashion. More particularly, the results are passed onto to the service portal 105 where the results are displayed by another GUI generated by the controller module 210 of the service portal 105. In other embodiments, the service portal 105 can generate an overlay GUI to display the forwarded ranked search results.

Certain embodiments may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

What is claimed is:

1. A method of providing a profession social network, the method comprising:
providing a plurality of services in a service portal;
providing for a rating and a review for a plurality of service providers, the rating and review being associated with a service provided by the respective service provider;
receiving a request for a selected service; and
providing a sub-plurality of service providers of the plurality of service providers in response to the request, wherein the sub-plurality of services providers are ordered based on the associated rating and review.

2. The method of claim 1, further comprising:
receiving a new service provider at the service portal; and
posting the new service provider on a pending list.

3. The method of claim 2, further comprising:
retrieving the new service provider by a user;
receiving a rating and a review for the new service provider by the user; and
moving the new service provider from the pending list to a certified list.

4. The method of claim 1, further comprising determining a ranking associated with each service provider based on the rating, review and a secondary review, wherein the secondary review comprises a number of times the rating and review has been reviewed by other users and a usefulness rating of the rating and review.

5. The method of claim 4, further comprising storing the ranking of each service provider in a metadata associated with the each service provider.

6. The method of claim 1, further comprising:
searching third party websites and a pending list based on the request; and
providing the sub-plurality of service providers with a search result from the third party websites and the pending list.

7. The method of claim 1, wherein the plurality of service providers comprises at least one of independent software vendor, hardware vendor, and consultant.

8. The method of claim 1, comprising further ordering the sub-plurality of service providers by locality to an issuer of the request.

9. A system for a professional social network, the system comprising:
a network configured to allow communication among a plurality of users;
at least one server configured to execute software applications and coupled to the network;
a service portal configured to provide computer services to the plurality of users and configured to execute on the at least one server, wherein the service portal is configured to provide a plurality of services, to provide for a plurality of service providers, each service provider having an associated rating and review at least once and is associated with a service of the plurality of services, to receive a request for a selected service, and to provide a sub-plurality of service providers of the plurality of service providers in response to the request, the sub-plurality of services providers are ordered based on the associated rating and review.

10. The system of claim 9, wherein the service portal is configured to receive a new service provider to be added to the plurality of service providers and to post the new service provider on a pending list.

11. The system of claim 10, wherein the service portal is configured to retrieve the new service provider in response to a user requesting for the new service provider and to receive a rating and a review for the new service provider by the user, and to move the new service provider from the pending list to a certified list.

12. The system of claim 9, wherein the service portal is further configured to determine a ranking associated with each service provider based on the rating, review and a secondary review, wherein the secondary review comprises a number of times the rating and review has been reviewed by other users and a usefulness rating of the rating and review.

13. The system of claim 12, wherein the service portal is further configured to store the ranking of each service provider in a metadata associated with the each provider.

14. The system of claim 9, wherein the service portal is further configured to search third party websites based on the request and a pending list and to provide the sub-plurality of service providers with a search result from the third party websites and the pending list.

15. The system of claim 9, wherein the plurality of service providers comprises at least one entity providing one or more software, hardware, consulting, and training services.

16. The system of claim 9, wherein the service portal is configured to order the sub-plurality of service providers by locality to an issuer of the request.
